(19) United States
(12) Patent Application Publication
(10) Pub. No.: US 2005/0180433 A1
(43) Pub. Date: Aug. 18, 2005

(54) Bandwidth controller, network and IP subnetwork management process

(75) Inventors: Franck Jouenne, Ozoir-La-Ferriere (FR); Alban Couturier, Chatillon (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/055,666

(22) Filed: Feb. 11, 2005

(30) Foreign Application Priority Data
Feb. 18, 2004 (FR) 04 50 301

(51) Int. Cl. H04J 3/14; H04J 1/16; H04L 1/00; H04L 12/26; H04L 12/56; H04L 12/28

(52) U.S. Cl. 370/400; 370/229

(57) ABSTRACT

The invention relates to a bandwidth controller (9) able to: communicate with a network manager (10) and an IP subnetwork routing element (5,6,7,8); generate an IP microflow routing command according to instructions from the manager; send this command to the routing element. The invention also relates to a network equipped with such a controller.

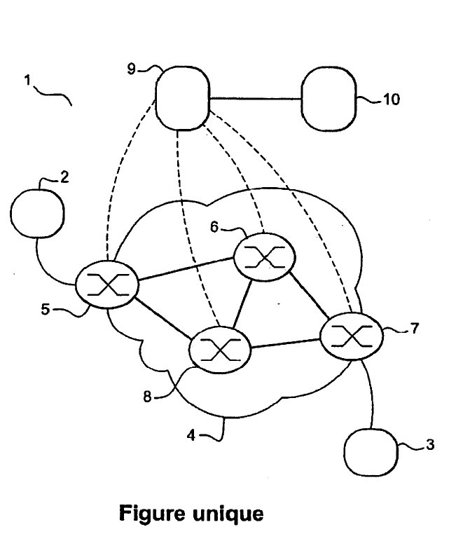

In addition, it relates to a subnetwork management process comprising the stages: (a) sending of instructions from a manager to a controller; (b) processing of instructions by the controller; where applicable (b′) a microflow routing request originating from a terminal (2) or a router (5); (c) sending of a routing command by the controller to a routing element (5,6,7,8), the routing command depending on instructions from the manager; and (d) the routing of a microflow.

The invention relates to a bandwidth controller, a network and an IP subnetwork management process for routing data within a network, and in particular the management of IP microflow routing within a subnetwork.

An IP microflow is an IP flow associated with a particular IP application and a transmitting terminal and receiving terminal. A microflow is determined by a group of 5 transported parameters (5-tuples): the IP protocol reference, the originating address, the destination address, the originating port number and the destination port number.

Currently, IP packet traffic within a subnetwork may be managed through MPLS (multiprotocol label switching), in other words a transmission technology used to allocate a label to an IP flow, providing information about the path that it must follow, so that it can be switched or routed more quickly on networks using different protocol types. This technology has a high granularity, however. Routers perform filtering according to rules predefined on activation of the subnetwork. The traffic is usually managed through filtering according to flow IP packet originating address ranges. Thus, if an originating site sends an IP packet flow considered to be important (for example, packets whose port numbers relate to a particular protocol that it has been decided to give priority to) the entire packet flow will follow the same path. This requires the allocating of resources (“size of pipes”) that are adequate for traffic estimations and the transport quality required. This technology is therefore likely cause to overloads on certain paths, which are undersized at a given time, or wastage if the paths are oversized at off peak times. The use of IP microflows, with contents such as voice or video implying technical constraints such as loss of packets, transmission times, or bandwidth, may be impaired by the slowing down of traffic due to overloads. Thus current routing management and traffic engineering processes do not allow sufficiently flexible routing. Furthermore, these processes do not guarantee a particular service quality according to the state of the network. This technology also does not permit the service quality associated with a microflow to be maintained on the closing of a path and the transferring of the total flow initially following this path to another path. Maintenance operations on the network, or faulty path elements, may therefore mean that path transferring/closing leads to service quality faults.

Bandwidth controllers are also available, such as those described by French patent application request publication number 2 835 987. Such a device provides a good level of granularity, taking into account microflows. However, it does not allow general information to be taken into account, in other words information concerning the network or subnetwork, which depend on several factors, such as contracts between service providers, the deployment of optimisation applications, etc.

There is therefore a need for a microflow management process and device that would resolve one or more of these disadvantages.

The invention first and foremost comprises a bandwidth controller able to communicate with at least one IP communication subnetwork routing element, characterised by the fact that it is also able to communicate with a network manager and:
Generate at least one IP microflow routing command according to routing instructions received from the network manager;
Send at least one routing command to at least one routing element.

According to one variant, the bandwidth controller also includes:
A network manager instruction interpreter;
A routing command generating module, in order to translate the routing instructions received from the network manager into routing commands to be transmitted to at least one routing element.

The invention also comprises a communication network consisting of:
An IP protocol communication subnetwork, equipped with several routing elements;
A routing manager;
A bandwidth controller as previously defined, able to communicate with at least one subnetwork routing element and with the network manager.

According to one variant, the network manager is in possession of subnetwork state measurements, and the network manager's instructions depend on these measurements.

According to one variant, one of the network's routing elements is a subnetwork boundary router.

According to one variant, at least one routing element is a network address translator.

According to one variant, the bandwidth controller and the network manager are incorporated within the same network element.

Thirdly, the invention comprises a communication subnetwork management process including the following stages:
a) Sending of routing instructions from a network manager to a bandwidth controller;
b) Processing of routing instructions by the bandwidth controller;
c) Sending of at least one IP microflow routing command by the bandwidth controller to at least one communication subnetwork routing element, this routing command being dependant on the routing instructions;
d) Routing of an IP microflow within the communication subnetwork according to at least one routing command sent in stage (c).

According to some variants,
The process also includes a stage (b′), consisting of a microflow routing request originating from a terminal, a server, another bandwidth controller communicating with the subnetwork or, indirectly, from a router.
The processing stage (b) includes a stage consisting of the interpreting by the controller of the routing instructions sent in stage (a).
The routing instructions sent in stage (a) include a request to suspend the IP microflow traffic on an initial routing path.
Stage (d) includes a stage of suspending the IP microflow traffic on the initial path.
Stage (d) also includes an IP microflow traffic transfer to a path other than the initial path.
The traffic suspension request is sent, in stage (a), following the detecting by the network manager of a request for maintenance on the initial path.
The process also includes the following stages:
   e) Sending by the routing element of a confirmation of the suspending of IP microflow traffic on the initial path to the bandwidth controller;
   f) Sending by the bandwidth controller of a traffic suspension confirmation to the network manager.
The process includes a prior subnetwork path state measuring stage, and the instructions sent in stage (a) depend on the subnetwork path state measuring.
The prior path state measuring stage includes measuring of the path's load.
The instructions sent in stage (a) depend on service quality routing rules.
The instructions sent in stage (a) depend on a type of microflow content.

The invention will now be described in more detail in below, and through reference to the single FIGURE, which illustrates an example of a communication network implementing the invention.

The invention proposes a process and a bandwidth module able to control the routing elements of an IP communication subnetwork, in order to set the routing of IP microflows according to rules defined by a network manager.

The FIGURE shows a communication network 1. This communication network comprises a transmitting terminal 2 in communication with a receiving terminal 3 by means of an IP subnetwork 4. The subnetwork consists of several routing elements 5 to 8 defining several routing paths between them. The routing elements 5 to 7 in the example are subnetwork boundary routers and the routing elements 6 and 8 are core routers of this subnetwork 4. The network elements 5 to 8 are controlled by a bandwidth controller 9. The bandwidth controller 9 is in communication with a network manager 10, also known as an NMS (Network Management System).

According to variants of the invention, the element referred to by the number 2 may be a server or another bandwidth controller (for example, associated with another subnetwork located upstream of the IP subnetwork 4).

The network manager 10 defines routing objectives and may bring together contextual data concerning the subnetwork. The network manager 10 has detailed knowledge of the network. The network may, for example, have been configured by the network manager 10. The role of the network manager 10 is to provide routing instructions to the bandwidth controller, particularly in situations where the controller needs to redirect flows.

For example, for flows needing to go from A to B, these routing instructions may be aimed at passing 60% of these flows through path A-C-B and 40% through path A-D-B. They may also target the use of a particular path up to a path use threshold percentage, above which flows are directed to other paths.

The network manager 10 thus provides microflow routing instructions according to the general routing rules at its disposal.

These rules are imposed, for example, by service quality contracts, concluded between a service provider who owns the subnetwork, and a customer who wishes to establish a traffic flow between terminals 2 and 3. They are referred to as service quality routing rules.

These rules may also be determined empirically according to the service provider's observations concerning traffic within the subnetwork. The rules may also be determined in order to reduce traffic costs, according to charging periods associated with certain routes.

Alternatively, the rules may be intended to share a microflow load within the subnetwork. For example, a request may be made for the distribution of video over IP traffic between several routes to avoid overloading a particular route within the subnetwork.

The bandwidth controller 9 is provided with instructions according to these rules, for example using a transport code compliant with the CORBA architecture (Common Object Requester Broker Architecture) defined by OMG (Open Management Group) and/or a SOAP protocol (Simple Object Access Protocol).

The bandwidth controller 9 processes the routing instructions provided by the network manager 10. The processing function includes, in particular, the saving of the routing instructions received by the bandwidth controller.

Furthermore, the network manager's routing instructions are preferably not specifically adapted to the subnetwork 4. They may be more wider ranging. These instructions can in this case be translated into commands specific to the subnetwork by the bandwidth controller 9, which may incorporate an instruction interpreter for this purpose.

The bandwidth controller 9 generates microflow routing commands according to the routing instructions. The bandwidth controller 9 can then send microflow routing commands to one or several of the subnetwork's elements. The bandwidth controller may generate routing commands specific to the subnetwork according to various data made available to it, for example in a database. These data might also be transmitted to the bandwidth controller 9 by the network manager 10. The bandwidth controller 9 may, for example, be in possession of information about the subnetwork's topology or of tables detailing the routing within this subnetwork 4. The bandwidth controller 9 may also have access to data relating to the subnetwork's context, such as the load on various of the subnetwork's paths, the packet loss rate (and more generally the service quality) on different subnetwork paths, or the instantaneous cost of a link within the subnetwork.

Depending on the type of instruction, the bandwidth controller may generate and send microflow routing commands to one of the subnetwork's elements, directly following the sending of specific instructions by the network manager, as will be discussed further on.

However, according to one variant, the network manager 10 sends instructions to the bandwidth controller 9, but the latter 9 only generates and sends microflow routing commands to a subnetwork element 5, 6, 7, 8 following a microflow routing request originating, for example, from a terminal 2, a server 2, or another bandwidth controller 2.

A typical scenario would be the following: a network manager 10 has provided instructions, based on a set of rules, to a bandwidth controller 10. A terminal 2 or a server 2 requests a service quality for a type or set of microflows to be transported (or routed) towards a client terminal 3. This request is transmitted to the bandwidth controller 9, which then generates and sends microflow routing commands to a subnetwork element 5, 6, 7, or 8, in order to ensure that the service quality requested is provided, while taking into account the instructions sent by the network manager 10.

The command generated by the bandwidth controller 9 is received by a network element and translated, in other words executed by this network element.

This network element may, for example, be a router or a network address translator (or NAT box, standing for Network Address Translation). In the following, however, we shall assume that the element is a router, for purposes of illustration. Note that some routers may have network address translator (NAT) functionalities.

The IP microflow routing is therefore carried out in a way specific to the subnetwork, according to general rules defined in the network manager 10. It is preferable to have this separation between the general routing rule definition function of the network manager 10 and the function that allows the applying of these routing rules by the bandwidth controller 9. This separation frees the bandwidth controller from determining routing rules and therefore improves routing element control.

Supposing that the network manager 10 in the FIGURE provides the bandwidth controller 9 with instructions to share the voice over IP microflow load within the subnetwork 4, the bandwidth controller will generate and send an appropriate command to the routing element 5 (for example following a routing request originating from a terminal 2, a server 2, or another controller 2). This command may request that the routing element 5 routes half of the voice over IP microflows originating from the terminal 2 along the path 5-6-7 and the other half of the voice over IP microflows along 5-8-7, the FIGUREs identifying the paths corresponding to the references of the network elements through which the microflows successively pass.

Let us also suppose that the network manager 10 has sent a “take the least expensive path for voice over IP microflows” request. Following a routing request originating from a terminal 2, a server 2, or another controller 2, the bandwidth controller 9 may, for example, determine that path 5-6-7 is the least costly, according to costing data in the possession of the controller 9, or that have been provided by the network manager 10. The bandwidth controller 9 in this case generates and sends, to router 5, a command to route voice over IP microflows only on path 5-6-7 between routers 5 and 7. The change in routing then takes place in a way that is transparent for the user.

The bandwidth controller 9 may also define routing commands for new microflows passing through the subnetwork 4. On the receiving of a new microflow on the router 5, the router 5 might therefore communicate certain of the microflow's properties, such as the microflow's protocol, the microflow's destination IP address, or any other property relevant to routing. Within the context of the present patent, the notion of “microflow routing request” may include the communicating by the router 5 of the properties above to the controller 9.

In addition, a microflow routing request originating from a terminal 2, a server 2, or any other controller 2, may itself indirectly originate (in other words pass through) from a router 5 that communicates it to the controller 9.

The bandwidth controller 9 in this case determines the microflow routing path(s) and generates a corresponding routing command. The router receives and executes this command. The new microflow may then take a path corresponding to the general rules of network manager 10 and/or, where applicable, to a request originating from a terminal 2, a server 2, or another controller 2. The changing of a new microflow's routing is therefore carried out in a way that is transparent for the user. The routing is thus performed according to the invention at microflow level, rather than aggregate level, according to the microflow's parameters. The routing can in this way be carried out with low granularity. The flexibility of the routing's management is improved, which in particular prevents overloads within the subnetwork. Different service qualities can also be provided for each microflow.

As mentioned above, the routing of an IP microflow within the subnetwork might also be modified by any appropriate means. For example, the use of network address translators might be considered for this purpose.

According to a variant, the functionalities of the bandwidth controller 9 and the network manager 10 may be combined within a single element, such as a rule server, or PDP (Policy Destination Point). The functionalities of the bandwidth controller 9 and the network manager 10 may, for example, be implemented in software form in a terminal communicating with the network elements 5 to 7.

Although in the FIGURE the bandwidth controller is shown communicating with the routing elements 5 to 8, it may of course be envisaged for the microflow routing commands to only be sent to an appropriate number of routing elements. This would mean that, for the whole of the FIGURE, the routing commands might only be sent to the boundary router 5 of the subnetwork 4.

One management process variant is aimed at making the closing of a path routing an IP microflow within a subnetwork transparent and predictable for a microflow user. According to this variant, the network manager 10 transmits instructions to the bandwidth controller 9. These instructions may, for example, contain a request for the suspending of a route or, more generally, for the changing of the service quality property for a route. This means that, following a request, a route may no longer be qualified for microflow traffic of a given type, for example voice. Maintenance might be carried out on the physical link between the routing elements 6 and 7, for example. A link might also be avoided by looking for cheaper routes at certain times. Supposing that this link provides the transferring of voice over IP microflows, the instructions may, for example, contain a request banning any new Voice over IP microflows on this link. By way of example, a new telephone conversation passing through the subnetwork would be considered to be a new voice over IP microflow. Generally speaking, requests may be envisaged banning new microflows of a given type on a link, completely banning microflows of a given type on a link, deduplicating a type of microflow to be banned on the link on another link, or any request aimed at changing service quality.

The bandwidth controller 9 may inform the network manager 10 of the type of ban currently implemented on the link. The bandwidth controller 9 may, in particular, inform the network manager 10 that the link has been freed up. The network manager may then, for example, indicate to an operator that maintenance may be carried out on this link. The bandwidth controller 9 may also inform the network manager 10 of a planned time before the banning of the link becomes effective. The bandwidth controller 9 might also receive an end of link interruption instruction issuing from the network manager 10. The bandwidth controller 9 might then send commands re-establishing the microflow on the freed up link to the appropriate routing elements. The microflow may then be routed as initially by means of the re-established link. In this way, maintenance may be carried out in a way that is transparent for the user and for applications initially using this link.

If the bandwidth controller 9 determines that the microflow using a link to be interrupted cannot be rerouted, the bandwidth controller 9 might transmit, towards the network manager 10, or directly towards the terminals 2 or 3, an indication that this microflow will be interrupted without rerouting.

As a variant, the bandwidth controller 9 might send a general feedback message, towards the network manager 10, or directly towards terminals 2 or 3, including, for example, statistics relating to the microflows concerned, such as their number and percentage.

In addition, the bandwidth controller 9 may transmit an indication of the time before the suspending (here, the interruption) of the microflow's routing. The bandwidth controller 9 may also transmit an indication that a new flow may not be routed within the subnetwork 4, for example following this time period. If a terminal 2, 3 has itself requested a service quality, the controller may also transmit such indications to the terminal 2, 3.

The microflow traffic may therefore preferably be suspended with a time delay.

The routing of the microflow, which initially passed through the banned link, is carried out by any appropriate means. The network manager 10 may thus provide instructions for the distribution of the microflow between several other paths, in order to share out the load within the subnetwork. The bandwidth controller 9 may also change the routing of other microflows according to the microflow removed from the banned link.

The present variants and examples are given by way of illustration and are not restrictive. The invention is not deemed to be limited to the details provided here, but may be modified, while staying within the scope of the claims appended. Therefore, although a receiving and a transmitting terminal are described in the example, the invention of course applies to both directions in the microflow transfer process, or to terminals 2, 3, which are just intermediate elements in the transferring of microflows.

1. Bandwidth controller (9) able to communicate with at least one routing element (5,6,7,8) of an IP communication subnetwork, characterised by the fact that it is also able to communicate with a network manager (10) and to:
Generate at least one IP microflow routing command according to routing instructions received from said network manager;
Send said at least one routing command to said at least one routing element (5,6,7,8).

2. The bandwidth controller (9) of claim 1, comprising:
A network manager instruction interpreter;
A routing command generation module, in order to translate said routing instructions received from said network manager into routing commands to be transmitted to at least one said routing element.

3. Communication network (1) comprising:
An IP protocol communication subnetwork, equipped with several routing elements (5,6,7,8);
A network manager (10);
A bandwidth controller (9) according to claim 1; in which the controller is able to communicate with at least one of the subnetwork's routing elements (5,6,7,8) and with the network manager (10).

4. The network (1) of claim 3, characterised by the fact that:
The network manager (10) is in possession of subnetwork state measurements;
The network manager instructions depend on these measurements.

5. The network (1) of claim 3, characterised by the fact that at least one routing element (5,7) is a subnetwork boundary router.

6. The network of claim 3, characterised by the fact that at least one routing element (5,6,7,8) is a network address translator.

7. The network (1) of claim 3, characterised by the fact that the bandwidth controller (9) and the network manager (10) are incorporated within the same network element.

8. Communication subnetwork management process, comprising the following stages:
a) Sending of routing instructions from a network manager (10) to a bandwidth controller (9);
b) Processing by the bandwidth controller (9) of said routing instructions;
c) Sending of at least one IP microflow routing command by the bandwidth controller (9) to at least one routing element (5,6,7,8) of said communication subnetwork, said routing command depending on said routing instructions;
d) Routing of an IP microflow within said communication subnetwork, according to said routing command sent in stage (c).

9. The process of claim 8, also comprising a stage:
(b′) consisting of a microflow routing request originating from a terminal (2), a server (2), or another bandwidth controller (2) communicating with said subnetwork or, indirectly, from a router (5).

10. The process of claim 8, characterised by the fact that the processing stage (b) includes a stage consisting of the interpreting by the controller (9) of the routing instructions sent in stage (a).

11. The process of claim 8, characterised by the fact that:
The routing instructions sent in stage (a) include a request for the suspending of IP microflow traffic on an initial routing path;
Stage (d) includes a stage consisting of the suspending of the IP microflow traffic on the initial path.

12. The process of claim 11, characterised by the fact that stage (d) also includes an IP microflow traffic transfer onto a path other than the initial path.

13. The process of claim 11, characterised by the fact that the request for the suspending of traffic is sent, in stage (a), following the detecting by the network manager (10) of a request for maintenance on the initial path.

14. The process of claim 8, also including the stages:
Consisting of the sending by the routing element (5,6,7,8) of confirmation of the suspending of IP microflow traffic on the initial path to the bandwidth controller (9);
Consisting of the sending of confirmation of the suspending of traffic to the network manager (10) by the bandwidth controller (9);

15. The process of claim 8, characterised by the fact that:
The process includes a prior subnetwork path state measuring stage;
The instructions sent in stage (a) depend on the subnetwork path state measuring.

16. The process of claim 15, characterised by the fact that the prior path state measuring stage includes measuring of said path's load.

17. The process of claim 8, characterised by the fact that the routing instructions sent in stage (a) depend on service quality routing rules.

18. The process of claim 8, characterised by the fact that the routing instructions sent in stage (a) depend on a type of microflow content.
